(19) United States
(12) Patent Application Publication
(10) Pub. No.: US 2020/0151733 A1
(43) Pub. Date: May 14, 2020

(54) Method and System for Implementing Customer 360 Degree User Interface Platform for Displaying Aggregated Information Associated with Customer

(71) Applicant: CenturyLink Intellectual Property LLC, Broomfield, CO (US)

(72) Inventor: Gurpreet Singh Sidhu, Aurora, CO (US)

(21) Appl. No.: 16/366,978

(22) Filed: Mar. 27, 2019

Related U.S. Application Data
(60) Provisional application No. 62/757,311, filed on Nov. 8, 2018.

(51) Int. Cl. G06Q 30/00; G06F 3/0482

(52) U.S. Cl. CPC G06Q 30/016; G06F 3/0482

(57) ABSTRACT

Novel tools and techniques are provided for implementing customer 360° user interface platform for displaying aggregated information associated with each of a plurality of customers. In various embodiments, a computing system might receive, from a first data source, a first set of information associated with a customer of a service provider that includes data associated with service provided to the customer; might receive, from a second data source different from the first data source, a second set of information associated with the customer; might analyze the first and second sets of information to optimize organization of data associated with the customer. Based on the analysis, the computing system might generate a user interface for displaying the customer-associated data to a service provider representative to provide the representative with a robust and holistic view of the customer and the customer's service requirements for enabling provisioning of enhanced service to the customer.

### CROSS-REFERENCES TO RELATED APPLICATIONS

This application claims priority to U.S. Patent Application Ser. No. 62/757,311 (the “'311 Application”), filed Nov. 8, 2018 by Gurpreet Singh Sidhu (attorney docket no. 1520-US-P1), entitled, “Method and System for Implementing Customer 360 Degree User Interface Platform for Displaying Aggregated Information Associated with Customer,” the disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing user interface platforms for displaying information, and, more particularly, to methods, systems, and apparatuses for implementing customer 360° user interface platform for displaying aggregated information associated with each of a plurality of customers.

### BACKGROUND

In conventional service provider systems, data associated with a particular customer of a service provider might be stored in different databases according to the type of data. For example, order information associated with the customer (and perhaps leads or opportunities associated with the customer (if any)) might be stored with the sales department of the service provider, while service and usage data associated with the customer (and perhaps any network asset data, service data, and/or product data, or the like that might be used to provide the service to the customer) might be stored with the technical or service department of the service provider, and account and billing data associated with the customer might be stored with the billing department, while information regarding incidents and/or issues encountered by the customer while using the service provided by the service provider might be stored with the customer service department. In some cases, the service provider might not even track or store information regarding interactions between the customer and the service provider.

Because of the disparate nature of the storage of information associated with the customer by the typical service provider, the services provided by the service provider to the customer would be limited, and the interactions between the service provider and the customer may be strained especially when issues and problems with the service to the customer arise. In such situations, if the service provider's various representatives or agents are unable to view all aspects of the service and information associated with the customer when interacting with the customer, the representatives or agents might require the customer to repeat himself or herself when describing the problems or issues, or might delay the response and remedial measures because the representatives or agents are unable to quickly determine the solution to the problems or issues (or even identify the correct problems or issues) due to lack of aggregation and/or analysis of all the data associated with the customer as applied to the services provided to the customer by the service provider.

Such conventional systems would likely also lack the ability to access, much less retrieve (and analyze) information associated with the user that are not related to the service provider itself, and therefore lack another facet of information that may be used to further facilitate interactions and improve service to the customer.

Hence, there is a need for more robust and scalable solutions for implementing user interface platforms for displaying information, and, more particularly, to methods, systems, and apparatuses for implementing customer 360° user interface platform for displaying aggregated information associated with each of a plurality of customers.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing customer 360° user interface platform for displaying aggregated information associated with each of a plurality of customers, in accordance with various embodiments.

FIG. 2 is a schematic diagram illustrating another system for implementing customer 360° user interface platform for displaying aggregated information associated with each of a plurality of customers, in accordance with various embodiments.

FIG. 3 is a schematic diagram illustrating an example of the generation of a single customer view (“SCV”) that is generated by customer 360° user interface platform and that displays aggregated information associated with a customer, in accordance with various embodiments.

FIG. 4 is a graphical diagram illustrating an example of relationships between a customer icon and icons of each of account information, leads, opportunities, services, issues with services, complaints or feedback, and customer interactions with the service provider, etc., in accordance with various embodiments.

FIG. 5 is a schematic diagram illustrating a user device used by users that present graphical user interfaces configured for displaying an example of a graphical version of a SCV, in accordance with the various embodiments.

FIG. 6 is a schematic diagram illustrating a user device used by users that present graphical user interfaces configured for displaying an example of a tabular version of a SCV, in accordance with the various embodiments.

FIGS. 7A and 7B are flow diagrams illustrating a method for implementing customer 360° user interface platform for displaying aggregated information associated with each of a plurality of customers, in accordance with various embodiments.

FIG. 8 is a block diagram illustrating an exemplary computer or system hardware architecture, in accordance with various embodiments.

FIG. 9 is a block diagram illustrating a networked system of computers, computing systems, or system hardware architecture, which can be used in accordance with various embodiments.

### DETAILED DESCRIPTION OF CERTAIN EMBODIMENTS

Overview

Various embodiments provide tools and techniques for implementing user interface platforms for displaying information, and, more particularly, to methods, systems, and apparatuses for implementing customer 360° user interface platform for displaying aggregated information associated with each of a plurality of customers.

In various embodiments, a computing system might receive, from a first data source, a first set of information associated with a customer of a service provider, the first set of information including a plurality of data that is associated with service provided to the customer by the service provider. The computing system might also receive, from a second data source that is different from the first data source, a second set of information associated with the customer. The computing system might analyze the first set of information and the second set of information to optimize organization of data associated with the customer. Based on the analysis, the computing system might generate a user interface (“UI”) for displaying the data associated with the customer to a representative of the service provider to provide the representative with a robust and holistic view of the customer and service requirements of the customer for enabling the representative to provide enhanced service to the customer. The computing system might display, on a display screen, the UI to the representative.

In some embodiments, the first set of information might include, without limitation, at least one of account information for the customer that is associated with the service provided by the service provider, billing information for the customer that is associated with the service provided by the service provider, product information for each product that is used by the customer and that is associated with the service provided by the service provider, order information for the customer that is associated with products and services ordered by the customer for the service provided by the service provider, communications information for any interactions between the customer and representatives of the service provider, service information for services provided by the service provider that are used by the customer, usage information for usage of products and services provided by the service provider that are used by the customer, information regarding any incidents encountered by the customer when using the products and services provided by the service provider, information regarding any issues encountered by the customer when using the products and services provided by the service provider, information regarding network assets that are utilized to enable the customer to use the products and services provided by the service provider, information regarding leads that the service provider can utilize to initiate communications with the customer to encourage the customer to order new products or services, information regarding leads that the service provider can utilize to initiate communications with one or more potential new customers who are known by the customer to encourage the one or more potential customers to order new products or services, information regarding opportunities that the service provider can take advantage of to encourage the customer to order new products or services, or information regarding opportunities that the service provider can take advantage of to encourage the one or more potential new customers to order new products or services, and/or the like. In some cases, the first set of information might include all data that is associated with service provided to the customer by the service provider.

According to some embodiments, the second set of information might include data that is associated with the customer but is not associated with the service provided by the service provider. In some instances, the second set of information might include, but is not limited to, at least one of information regarding feedback or likes posted online by the customer associated with products and services used by the customer that are not associated with the service provider, information regarding brands of products and services that are used by the customer and that are not associated with the service provider, information regarding analytics of online and offline interactions of the customer with service providers and retailers that are performed by third party analysis systems, information regarding social media presence or postings of the customer, or information regarding news articles read by the customer, and/or the like.

In some embodiments, the generated UI might be a graphical representation of groupings of related information associated with the customer and sets of unrelated information associated with the customer. Alternatively, the generated UI might be a tabular representation of sub-panels or sub-windows representing groupings of related information associated with the customer and sets of unrelated information associated with the customer.

According to some embodiments, at least one of receiving the first set of information from the first data source or receiving the second set of information from the second data source might comprise receiving real-time data feeds of information associated with the customer, and analyzing the first set of information and the second set of information might comprise continuously analyzing the received real-time data feeds and any non-real-time data feeds to optimize the organization of data associated with the customer. In such cases, the computing system 105 might update the generated UI based on the continuously analyzed real-time data feeds and any non-real-time data feeds to provide the representative with a continuously updated robust and holistic view of the customer and service requirements of the customer for enabling the representative to provide enhanced service to the customer; and might display, on the display screen, the updated UI.

In this manner, the system can generate a single customer view (“SCV”) either in graphical form and/or in tabular form in order to provide a representative(s) of a service provider with a holistic view of the information associated with the customer that is also associated with services provided to the customer by the service provider (and, in some cases, also providing in the holistic view information associated with the customer that is not associated with the service provider, but would nonetheless provide further insights to the representative(s) with information to improve interactions with the customer and/or to improve the services provided to the customer by the service provider). In some embodiments, insights data generated from a combination of the first party data (accumulated by the service provider) and third party data (accumulated by third party sources concerning the customer that are not associated to the service provider) might also be displayed in the SCV to further improve interactions with the customer and/or to improve the services provided to the customer by the service provider.

These and other functions of the system and method are described in greater detail above with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, data aggregation and display systems, customer interaction systems, customer interface systems, customer service tool systems, and/or the like. In other aspects, certain embodiments, can improve the functioning of user equipment or systems themselves (e.g., data aggregation and display systems, customer interaction systems, customer interface systems, customer service tool systems, etc.), for example, by receiving, with a computing system and from a first data source, a first set of information associated with a customer of a service provider, the first set of information including a plurality of data that is associated with service provided to the customer by the service provider; receiving, with the computing system and from a second data source that is different from the first data source, a second set of information associated with the customer; analyzing, with the computing system, the first set of information and the second set of information to optimize organization of data associated with the customer; based on the analysis, generating, with the computing system, a user interface (“UI”) for displaying the data associated with the customer to a representative of the service provider to provide the representative with a robust and holistic view of the customer and service requirements of the customer for enabling the representative to provide enhanced service to the customer; and displaying, with the computing system and on a display screen, the UI to the representative; and/or the like.

In particular, to the extent any abstract concepts are present in the various embodiments, those concepts can be implemented as described herein by devices, software, systems, and methods that involve specific novel functionality (e.g., steps or operations), such as, periodically and/or continuously aggregating first party data associated with the customer (and accumulated and stored by the various databases of a service provider providing service to the customer), periodically and/or continuously aggregating third party data associated with the customer but not associated with the service provider (and accumulated and stored by third party sources and/or data aggregators, or the like), and (perhaps also) generating insights data regarding the customer based on analysis of such first party data and/or third party data, and analyzing the first party data, the third party data, and/or the insights data (if any) to generate a single customer view user interface that may be in graphical form and/or tabular form to provide the representative of the service provider with a robust and holistic view of the customer and service requirements of the customer for enabling the representative to provide enhanced service to the customer, and to display the UI to the representative, and/or the like, to name a few examples, that extend beyond mere conventional computer processing operations. These functionalities can produce tangible results outside of the implementing computer system, including, merely by way of example, optimized presentation and customization of first party, third party, and/or insights data associated with the customer to provide the representative with a robust and holistic view of the customer and service requirements of the customer for enabling the representative to provide enhanced service to the customer, and/or the like, at least some of which may be observed or measured by customers and/or service providers.

In an aspect, a method might comprise receiving, with a computing system and from a first data source, a first set of information associated with a customer of a service provider, the first set of information including a plurality of data that is associated with service provided to the customer by the service provider; and receiving, with the computing system and from a second data source that is different from the first data source, a second set of information associated with the customer. The method might also comprise analyzing, with the computing system, the first set of information and the second set of information to optimize organization of data associated with the customer; and based on the analysis, generating, with the computing system, a user interface (“UI”) for displaying the data associated with the customer to a representative of the service provider to provide the representative with a robust and holistic view of the customer and service requirements of the customer for enabling the representative to provide enhanced service to the customer. The method might further comprise displaying, with the computing system and on a display screen, the UI to the representative.

In some embodiments, the first set of information might comprise at least one of account information for the customer that is associated with the service provided by the service provider, billing information for the customer that is associated with the service provided by the service provider, product information for each product that is used by the customer and that is associated with the service provided by the service provider, order information for the customer that is associated with products and services ordered by the customer for the service provided by the service provider, communications information for any interactions between the customer and representatives of the service provider, service information for services provided by the service provider that are used by the customer, usage information for usage of products and services provided by the service provider that are used by the customer, information regarding any incidents encountered by the customer when using the products and services provided by the service provider, information regarding any issues encountered by the customer when using the products and services provided by the service provider, information regarding network assets that are utilized to enable the customer to use the products and services provided by the service provider, information regarding leads that the service provider can utilize to initiate communications with the customer to encourage the customer to order new products or services, information regarding leads that the service provider can utilize to initiate communications with one or more potential new customers who are known by the customer to encourage the one or more potential customers to order new products or services, information regarding opportunities that the service provider can take advantage of to encourage the customer to order new products or services, or information regarding opportunities that the service provider can take advantage of to encourage the one or more potential new customers to order new products or services, and/or the like. In some instances, the first set of information might include all data that is associated with service provided to the customer by the service provider.

According to some embodiments, the second set of information might include data that is associated with the customer but is not associated with the service provided by the service provider. In some cases, the second set of information might comprise at least one of information regarding feedback or likes posted online by the customer associated with products and services used by the customer that are not associated with the service provider, information regarding brands of products and services that are used by the customer and that are not associated with the service provider, information regarding analytics of online and offline interactions of the customer with service providers and retailers that are performed by third party analysis systems, information regarding social media presence or postings of the customer, or information regarding news articles read by the customer, and/or the like.

In some embodiments, the method might further comprise generating, with the computing system, insights data associated with the customer based on the analysis of the first set of information and the second set of information. In some cases, the generated insights data associated with the customer might comprise at least one of a service health score indicative of health of the service provided to the customer by the service provider, a satisfaction score indicative of the customer's satisfaction with the service provided to the customer by the service provider, an experience index indicative of the customer's known experience with the service provided to the customer by the service provider, a lifetime value index indicative of an estimate of a probability that the customer will continue using or ordering services offered by the service provider over a lifetime of the customer, information regarding predicted delays between issues with the service provided by the service provider and encountered by the customer and resolution of the issues by the service provider, information indicative of a propensity of the customer to order new products or services from the service provider, or information indicative of a probability that the customer will present a churn risk to the service provider, and/or the like.

In some instances, at least one of receiving the first set of information from the first data source or receiving the second set of information from the second data source might comprise receiving real-time data feeds of information associated with the customer, and analyzing the first set of information and the second set of information might comprise continuously analyzing the received real-time data feeds and any non-real-time data feeds to optimize the organization of data associated with the customer. In such cases, the method might further comprise updating, with the computing system, the generated UI based on the continuously analyzed real-time data feeds and any non-real-time data feeds to provide the representative with a continuously updated robust and holistic view of the customer and service requirements of the customer for enabling the representative to provide enhanced service to the customer. In some cases, the method might further comprise displaying, on the display screen, the updated UI.

According to some embodiments, analyzing the first set of information and the second set of information to optimize organization of data associated with the customer might comprise removing duplicative information associated with the customer and consolidating records associated with the customer. Alternatively, or additionally, analyzing the first set of information and the second set of information might comprise performing at least one of: linking, with the computing system, the customer to an account with the service provider; linking, with the computing system, the account with all orders for services and products from the service provider that are ordered or used by the customer; linking, with the computing system, all products associated with the service provider that are used by the customer to the account; linking, with the computing system, the account to bills for services provided by the service provider to the customer and to payments made by the customer to the service provider; linking, with the computing system, two or more notifications sent to the customer or related to service provided to the customer by the service provider; linking, with the computing system, service tickets to services or products used by the customer as part of the service provided by the service provider; linking, with the computing system, two or more digital dialog preferences of the customer; linking, with the computing system, a modem or gateway device of the customer to the account and to products used by the customer as part of the service provided by the service provider; linking, with the computing system, the modem or gateway device of the customer to a preceding time period of usage data; or linking, with the computing system, the account to billing information and a shipping address of the customer, and/or the like.

In some embodiments, the method might further comprise generating at least one of advertisements or customer experience that is tailored to the customer based on the information displayed in the robust and holistic view of the customer in the generated UI.

Merely by way of example, in some cases, the generated UI might be a graphical representation of groupings of related information associated with the customer and sets of unrelated information associated with the customer. Alternatively, and/or additionally, the generated UI might be a tabular representation of sub-panels or sub-windows representing groupings of related information associated with the customer and sets of unrelated information associated with the customer.

In another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: receive, from a first data source, a first set of information associated with a customer of a service provider, the first set of information including a plurality of data that is associated with service provided to the customer by the service provider; receive, from a second data source that is different from the first data source, a second set of information associated with the customer; analyze the first set of information and the second set of information to optimize organization of data associated with the customer; based on the analysis, generate a user interface (“UI”) for displaying the data associated with the customer to a representative of the service provider to provide the representative with a robust and holistic view of the customer and service requirements of the customer for enabling the representative to provide enhanced service to the customer; and display, on a display screen, the UI to the representative.

According to some embodiments, the apparatus might comprise one of a server computer over a network, a cloud-based computing system over a network, or a distributed computing system, and/or the like. In some embodiments, the set of instructions, when executed by the at least one processor, further causes the apparatus to: generate insights data associated with the customer based on the analysis of the first set of information and the second set of information. The generated insights data associated with the customer might comprise at least one of a service health score indicative of health of the service provided to the customer by the service provider, a satisfaction score indicative of the customer's satisfaction with the service provided to the customer by the service provider, an experience index indicative of the customer's known experience with the service provided to the customer by the service provider, a lifetime value index indicative of an estimate of a probability that the customer will continue using or ordering services offered by the service provider over a lifetime of the customer, information regarding predicted delays between issues with the service provided by the service provider and encountered by the customer and resolution of the issues by the service provider, information indicative of a propensity of the customer to order new products or services from the service provider, or information indicative of a probability that the customer will present a churn risk to the service provider, and/or the like.

In some embodiments, analyzing the first set of information and the second set of information to optimize organization of data associated with the customer might comprise removing duplicative information associated with the customer and consolidating records associated with the customer. Alternatively, or additionally, analyzing the first set of information and the second set of information might comprise performing at least one of: linking the customer to an account with the service provider; linking the account with all orders for services and products from the service provider that are ordered or used by the customer; linking all products associated with the service provider that are used by the customer to the account; linking the account to bills for services provided by the service provider to the customer and to payments made by the customer to the service provider; linking two or more notifications sent to the customer or related to service provided to the customer by the service provider; linking service tickets to services or products used by the customer as part of the service provided by the service provider; linking two or more digital dialog preferences of the customer; linking a modem or gateway device of the customer to the account and to products used by the customer as part of the service provided by the service provider; linking the modem or gateway device of the customer to a preceding time period of usage data; or linking the account to billing information and a shipping address of the customer, and/or the like.

According to some embodiments, the set of instructions, when executed by the at least one processor, might further cause the apparatus to: generate at least one of advertisements or customer experience that is tailored to the customer based on the information displayed in the robust and holistic view of the customer in the generated UI.

In yet another aspect, a system might comprise a computing system, which might comprise at least one processor and a non-transitory computer readable medium communicatively coupled to the at least one processor. The non-transitory computer readable medium might have stored thereon computer software comprising a set of instructions that, when executed by the at least one processor, causes the computing system to: receive, from a first data source, a first set of information associated with a customer of a service provider, the first set of information including a plurality of data that is associated with service provided to the customer by the service provider; receive, from a second data source that is different from the first data source, a second set of information associated with the customer; analyze the first set of information and the second set of information to optimize organization of data associated with the customer; based on the analysis, generate a user interface (“UI”) for displaying the data associated with the customer to a representative of the service provider to provide the representative with a robust and holistic view of the customer and service requirements of the customer for enabling the representative to provide enhanced service to the customer; and display, on a display screen, the UI to the representative.

In some embodiments, the computing system might comprise one of a server computer over a network, a cloud-based computing system over a network, or a distributed computing system, and/or the like.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

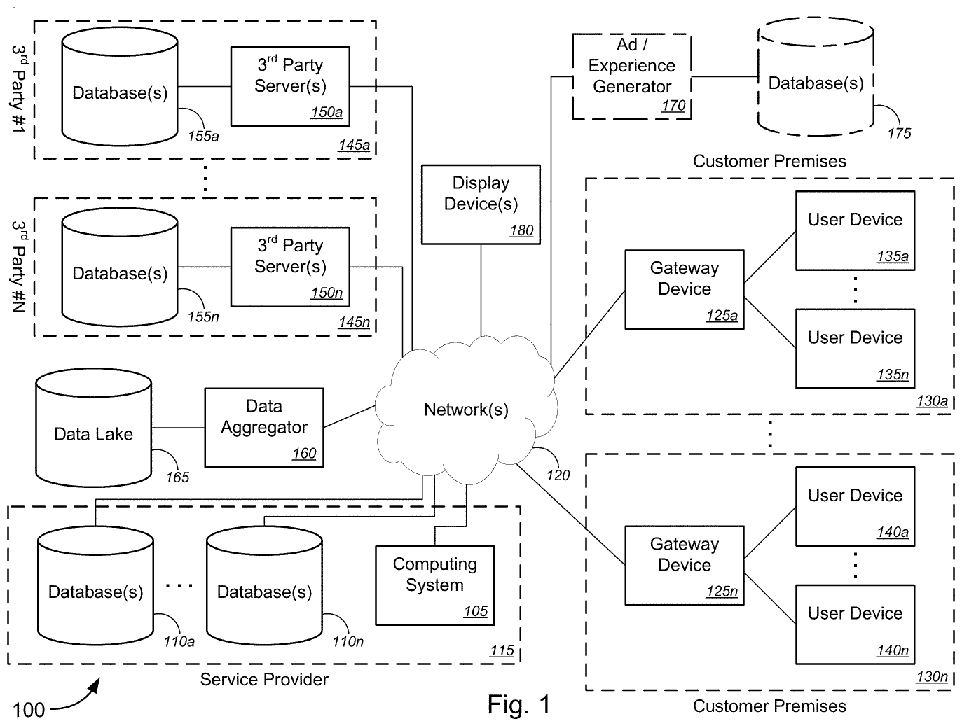

We now turn to the embodiments as illustrated by the drawings. FIGS. 1-9 illustrate some of the features of the method, system, and apparatus for implementing user interface platforms for displaying information, and, more particularly, to methods, systems, and apparatuses for implementing customer 360° user interface platform for displaying aggregated information associated with each of a plurality of customers, as referred to above. The methods, systems, and apparatuses illustrated by FIGS. 1-9 refer to examples of different embodiments that include various components and steps, which can be considered alternatives or which can be used in conjunction with one another in the various embodiments. The description of the illustrated methods, systems, and apparatuses shown in FIGS. 1-9 is provided for purposes of illustration and should not be considered to limit the scope of the different embodiments.

With reference to the figures, FIG. 1 is a schematic diagram illustrating a system 100 for implementing customer 360° user interface platform for displaying aggregated information associated with each of a plurality of customers, in accordance with various embodiments.

In the non-limiting embodiment of FIG. 1, system 100 might comprise computing system 105 and databases 110a-110n (collectively, “databases 110” or the like), each associated with a service provider 115. System 100 might further comprise one or more networks 120. In some embodiments, system 100 might comprise one or more gateway devices 125a-125n (collectively, “gateway devices 125” or the like), one or more customer premises 130a-130n (collectively, “customer premises 130” or the like), one or more user devices 135a-135n (collectively, “user devices 135” or the like), and one or more user devices 140a-140n (collectively, “user devices 140” or the like). For example, gateway device 125a and user devices 135 might be disposed within customer premises 130a and might be associated with a first customer among a plurality of customers of the service provider 115, while gateway device 125n and user devices 140 might be disposed within customer premises 130n and might be associated with an N^{th} customer among the plurality of customers of the service provider 115.

According to some embodiments, system 100 might refer to one or more third parties #1 to # N 145a-145n (collectively, “third parties 145” or the like). Each third party 145 might have an associated third party server(s) 150 and corresponding database(s) 155. For instance, third party 145a might have an associated third party server(s) 150a and corresponding database(s) 155a, while third party 145n might have an associated third party server(s) 150n and corresponding database(s) 155n, and so on.

In some embodiments, system 100 might comprise a data aggregator 160 and corresponding data lake 165. In some cases, system 100 might further comprise an advertisement and/or experience generator 170 and corresponding database(s) 175. In some instances, system 100 might further comprise display devices 180.

In operation, computing system 105 might receive, from a first data source (e.g., database(s) 110a-110n, or the like), a first set of information associated with a customer (e.g., one of the first through N^{th} customer among the plurality of customers, or the like) of a service provider (e.g., service provider 115, or the like), the first set of information including a plurality of data that is associated with service provided to the customer by the service provider. The computing system 105 might receive, from a second data source that is different from the first data source (e.g., third party server(s) 150a-150n and/or corresponding databases 155a-155n, data aggregator 160 and/or data lake 165, and/or the like), a second set of information associated with the customer.

In some embodiments, the first set of information might include, without limitation, at least one of account information for the customer that is associated with the service provided by the service provider, billing information for the customer that is associated with the service provided by the service provider, product information for each product that is used by the customer and that is associated with the service provided by the service provider, order information for the customer that is associated with products and services ordered by the customer for the service provided by the service provider, communications information for any interactions between the customer and representatives of the service provider, service information for services provided by the service provider that are used by the customer, usage information for usage of products and services provided by the service provider that are used by the customer, information regarding any incidents encountered by the customer when using the products and services provided by the service provider, information regarding any issues encountered by the customer when using the products and services provided by the service provider, information regarding network assets that are utilized to enable the customer to use the products and services provided by the service provider, information regarding leads that the service provider can utilize to initiate communications with the customer to encourage the customer to order new products or services, information regarding leads that the service provider can utilize to initiate communications with one or more potential new customers who are known by the customer to encourage the one or more potential customers to order new products or services, information regarding opportunities that the service provider can take advantage of to encourage the customer to order new products or services, or information regarding opportunities that the service provider can take advantage of to encourage the one or more potential new customers to order new products or services, and/or the like. In some cases, the first set of information might include all data that is associated with service provided to the customer by the service provider.

In some cases, the first set of information might be accumulated and/or stored in databases 110a-110n by the service provider, such as every time information about the customer is updated, every time the customer orders services, every time the customer orders products, every time the customer provides feedback regarding services or products provided by the service provider, every time the customer submits complaints regarding issues or problems with the service or products provided by the service provider, every time the service provider generates billing invoices for the service(s) or product(s) provided by the service provider, every time network assets are assigned to provide service(s) to the service provider, every time leads and/or opportunities associated with the customer are discovered by service provider, every time the service provider communicates with the customer, and/or the like.

According to some embodiments, the second set of information might include data that is associated with the customer but is not associated with the service provided by the service provider. In some instances, the second set of information might include, but is not limited to, at least one of information regarding feedback or likes posted online by the customer associated with products and services used by the customer that are not associated with the service provider, information regarding brands of products and services that are used by the customer and that are not associated with the service provider, information regarding analytics of online and offline interactions of the customer with service providers and retailers that are performed by third party analysis systems, information regarding social media presence or postings of the customer, or information regarding news articles read by the customer, and/or the like.

In some instances, the second set of information might be accumulated and/or stored in databases 155a-155n by the third parties 145a-145n, might be accumulated and/or stored in data lake 165 by data aggregator 160, and/or the like, such as periodic and/or continuous accumulation or updating of information regarding feedback or likes posted online by the customer associated with products and services used by the customer that are not associated with the service provider, periodic and/or continuous accumulation or updating of information regarding brands of products and services that are used by the customer and that are not associated with the service provider, periodic and/or continuous accumulation or updating of information regarding analytics of online and offline interactions of the customer with service providers and retailers that are performed by third party analysis systems, periodic and/or continuous accumulation or updating of information regarding social media presence or postings of the customer, periodic and/or continuous accumulation or updating of information regarding news articles read by the customer, and/or the like.

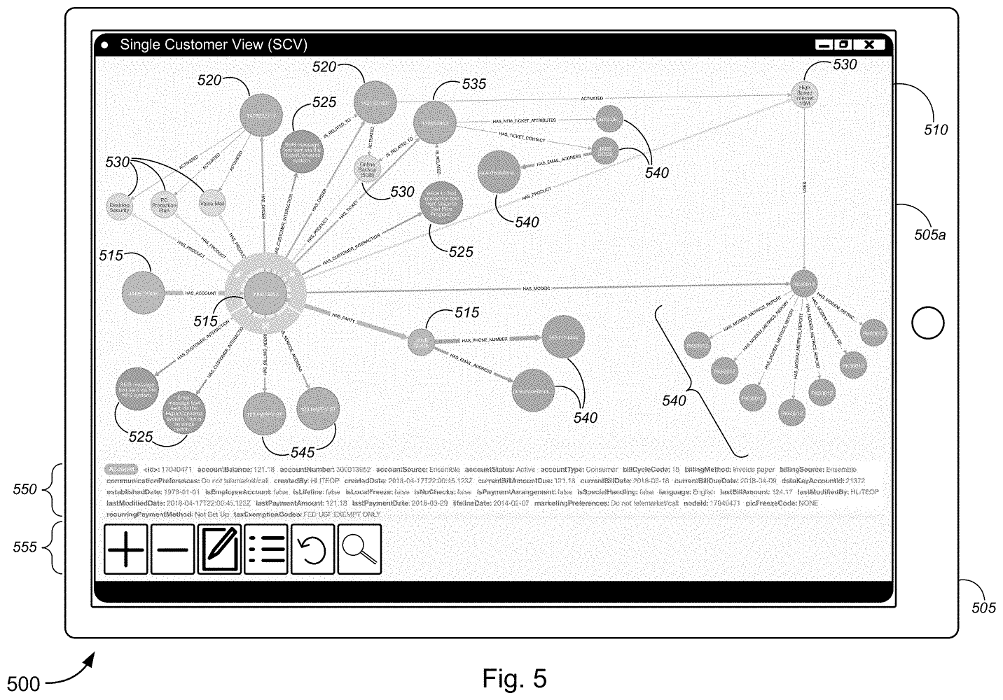

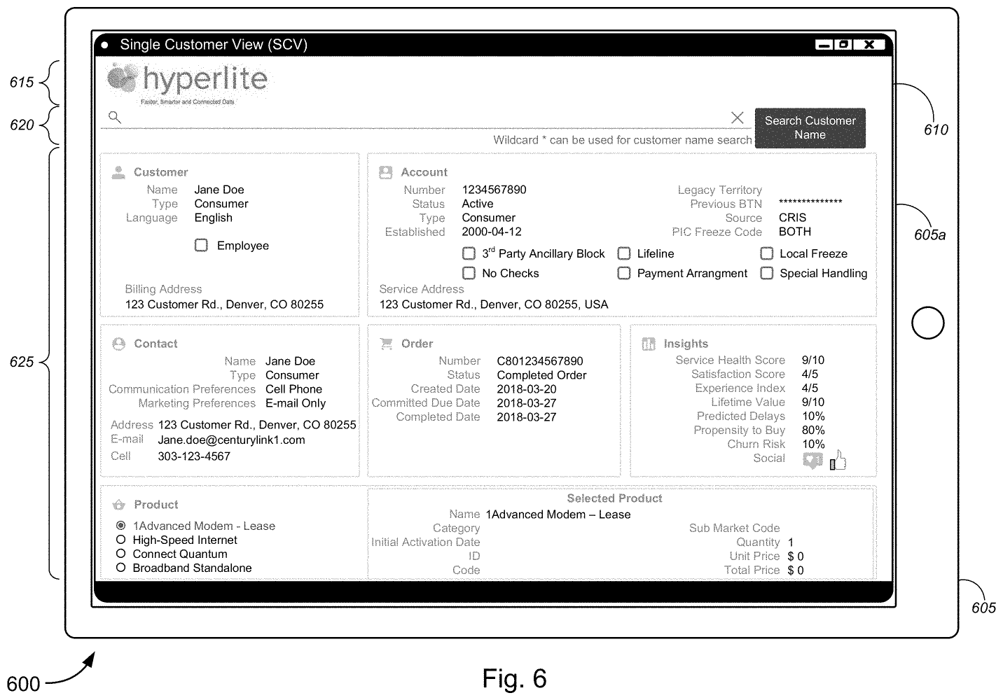

In some embodiments, the computing system 105 might comprise analyzing the first set of information and the second set of information to optimize organization of data associated with the customer. Based on the analysis, the computing system 105 might comprise generating a user interface (“UI”) for displaying the data associated with the customer to a representative of the service provider to provide the representative with a robust and holistic view of the customer and service requirements of the customer for enabling the representative to provide enhanced service to the customer. According to some embodiments, the generated UI might be a graphical representation of groupings of related information associated with the customer and sets of unrelated information associated with the customer (such as shown in, but not limited to, FIG. 5, or the like). Alternatively, and/or additionally, the generated UI might be a tabular representation of sub-panels or sub-windows representing groupings of related information associated with the customer and sets of unrelated information associated with the customer (such as shown in, but not limited to, FIG. 6, or the like). In some instances, the computing system 105 might display, on a display screen of display device(s) 180, the UI to the representative of the service provider 115. In some embodiments, machine learning or artificial intelligence (“AI”) systems may be used to sort through data that has been accumulated by the data aggregator 160 to determine whether each set of data is useful or not useful in terms of providing the robust and holistic view of the customer and the customer's service requirements. In some cases, such machine learning or AI systems may also be used to determine whether each set of data accumulated by the data aggregator 160 accurately reflects data associated with the customer or whether there are errors, inaccuracies, and/or intentional (i.e., nefarious) falsehoods in such data (in some cases, based on behavioral analysis of the activities and decisions made by the customer, or the like).

According to some embodiments, at least one of receiving the first set of information from the first data source or receiving the second set of information from the second data source might comprise receiving real-time data feeds of information associated with the customer, and analyzing the first set of information and the second set of information might comprise continuously analyzing the received real-time data feeds and any non-real-time data feeds to optimize the organization of data associated with the customer. In such cases, the computing system 105 might update the generated UI based on the continuously analyzed real-time data feeds and any non-real-time data feeds to provide the representative with a continuously updated robust and holistic view of the customer and service requirements of the customer for enabling the representative to provide enhanced service to the customer; and might display, on the display screen, the updated UI.

Merely by way of example, in some cases, the advertisement and/or experience generator 170 might generate at least one of advertisements or customer experience that is tailored to the customer based on the information displayed in the robust and holistic view of the customer in the generated UI or based on the information associated with the customer that are stored in any of the databases 110a-110n, 155a-155n, and/or 165. The generated at least one of advertisements or customer experience might be stored in database(s) 175.

In some embodiments, analyzing the first set of information and the second set of information to optimize organization of data associated with the customer might comprise removing duplicative information associated with the customer and consolidating records associated with the customer. According to some embodiments, analyzing the first set of information and the second set of information comprises performing at least one of: linking, with the computing system, the customer to an account with the service provider; linking, with the computing system, the account with all orders for services and products from the service provider that are ordered or used by the customer; linking, with the computing system, all products associated with the service provider that are used by the customer to the account; linking, with the computing system, the account to bills for services provided by the service provider to the customer and to payments made by the customer to the service provider; linking, with the computing system, two or more notifications sent to the customer or related to service provided to the customer by the service provider; linking, with the computing system, service tickets to services or products used by the customer as part of the service provided by the service provider; linking, with the computing system, two or more digital dialog preferences of the customer; linking, with the computing system, a modem or gateway device of the customer to the account and to products used by the customer as part of the service provided by the service provider; linking, with the computing system, the modem or gateway device of the customer to a preceding time period (e.g., previous year, previous month, previous quarter, previous seven days, previous few days, previous day, previous 12 hours, previous 6 hours, previous 2 hours, previous hour, previous half hour, etc.) of usage data; or linking, with the computing system, the account to billing information and a shipping address of the customer; and/or the like.

According to some embodiments, a security or privacy framework (not specifically shown in FIG. 1) might be used as a gateway to provide particular parties or individuals with access to the data associated with the customer, as well as to set the granularity of access to such data (e.g., full access, partial access, very limited access, no access, etc.) (i.e., to establish how much of such data may be accessed by each party or individual). In some instances, attribute-based access control may be implemented to control who (i.e., which parties or individuals) may access which data associated with the customer and how much access (e.g., full access, partial access, very limited access, no access, etc.) to such data may be provided to which parties or individuals.

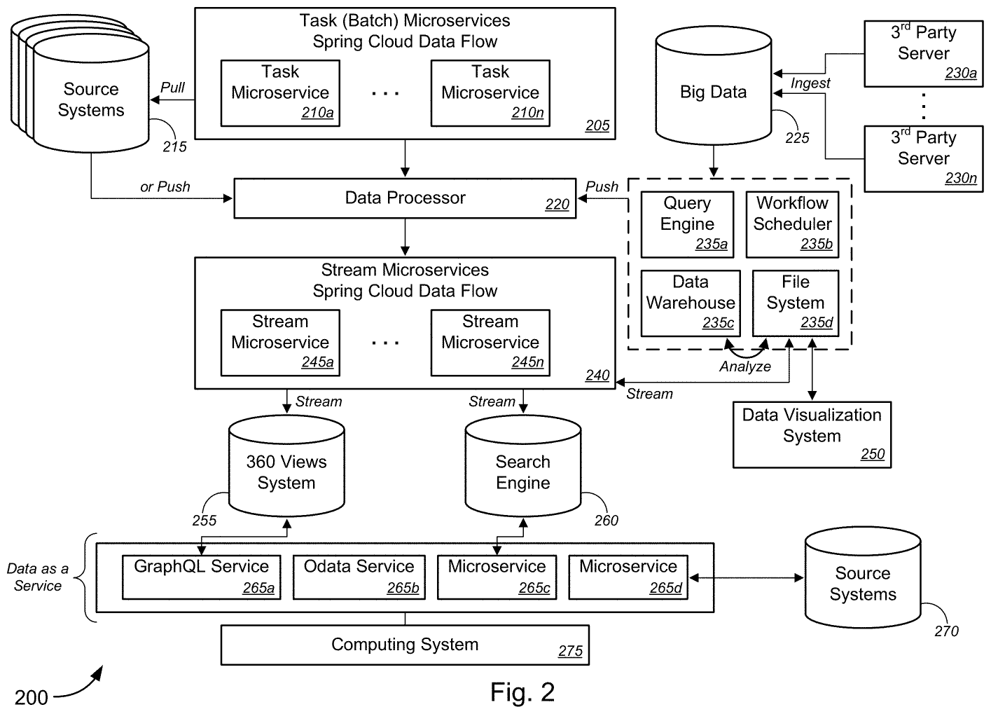

These and other functions of the system 100 (and its components) are described in greater detail above with respect to FIGS. 2-7.

FIG. 2 is a schematic diagram illustrating another system 200 for implementing customer 360° user interface platform for displaying aggregated information associated with each of a plurality of customers, in accordance with various embodiments.

In the non-limiting embodiment of FIG. 2, system 200 might comprise task (batch) microservices spring cloud data flow system 205, which might control one or more task microservice systems 210a-210n (collectively, “task microservice systems 210” or the like). System 200 might comprise a plurality of source systems 215, data processor 220, big data system 225, one or more third party servers 230a-230n (collectively, “third party servers 230” or the like), query engine 235a, workflow scheduler 235b, data warehouse 235c, and file system 235d. System 200 might further comprise stream microservices spring cloud data flow system 240, which might control one or more stream microservice systems 245a-245n (collectively, “stream microservice systems 245” or the like), and data visualization system 250. System 200 might further comprise 360° views system 255, search engine 260, GraphQL service system 265a, open data protocol (“Odata”) service system 265b, microservice systems 265c and 265d, and source systems 270. System 200 might further comprise computing system 275. In some cases, the GraphQL service system 265a, the Odata service system 265b, and the microservice systems 265c and 265d might collectively serve to provide data as a service (“DaaS”) to a customer of a service provider.

In operation, the source systems 215 might pull data produced or accumulated by the task (batch) microservices spring cloud data flow system 205 and/or by at least one of the one or more task microservice systems 210. The source systems 215 might push the data to data processor 220. Alternatively, or additionally, the data processor 220 might receive the data from the task (batch) microservices spring cloud data flow system 205 and/or by at least one of the one or more task microservice systems 210.

In some embodiments, the big data system 225 might ingest third party data that is associated with the customer (including, but not limited to, social media data, brand following data, contact analysis data, social update data, news update data, customer influence ranking data, feedback data by the customer, likes posted by the customer, and/or the like) and that might be stored in or accumulated by at least one of the one or more third party servers 230a-230n. The query engine 235a, which might include, without limitation, an open source massively parallel (“MPP”) SQL query engine, or the like (which, in some cases, might be embodied by Apache® Impala, or the like). The workflow scheduler 235b, which might include, but is not limited to, a server-based workflow scheduling system or the like (which, in some cases, might be embodied by Apache® Oozie, or the like). The data warehouse 235c, which might include, without limitation, a data warehouse software project for providing data query and analysis, or the like (which, in some cases, might be embodied by Apache® Hive, or the like). The file system 235d, which might include, but is not limited to, a Hadoop distributed file system (“HDFS”) for providing distributed, scalable, and portable file system framework, or the like. In operation, the workflow scheduler 235b might control or coordinate the query engine 235a to query the big data source 225 to retrieve the third party information associated with the customer of the service provider. The data warehouse 235c and/or the file system 235d might analyze the third party information, and the analyzed data might be further processed by the data visualization system 250. The query engine 235a, workflow scheduler 235b, data warehouse 235c, and/or the file system 235d might push the third party data to the data processor 220.

The stream microservices spring cloud data flow system 240 might receive the data from the data processor 220, and might stream data from the file system 235d and/or the data visualization system 250 via at least one of the stream microservice systems 245a-245n. In some embodiments, the framework including, without limitation, at least one of the task (batch) microservices spring cloud data flow system 205, the one or more task microservice systems 210a-210n, the source systems 215, the data processors 220, the big data system 225, the query engine 235a, the workflow scheduler 235b, the data warehouse 235c, the file system 235d, and/or the like might continuously ingest data from sources either by pulling data or by event streaming.

The data from the stream microservices spring cloud data flow system 240 and/or the stream microservice systems 245a-245n might stream the data to one or both of the 360° views system 255 and/or the search engine 260. In some cases, the 360° views system 255, which might include, without limitation, a graph database management system or the like (which might be embodied by Neo4j graph database platform, or the like), while the search engine 260, which might include, but is not limited to, an open source search platform or the like (which might be embodied by Apache® Solr, or the like). In some cases, the graphQL service system 265a might include, without limitation, an open source data query and manipulation system that allows to write application programming interface (“API”) in queryable form, or the like. The graphQL service system 265a (as controlled by computing system 275) might communicate with the 360° views system 255 to produce or generate a graphical representation of groupings of related information associated with the customer and sets of unrelated information associated with the customer (such as shown in, but not limited to, FIG. 5, or the like). Alternatively, and/or additionally, the microservice system 265c (as controlled by computing system 275) might communicate with the search engine system 260 to produce or generate a tabular representation of sub-panels or sub-windows representing groupings of related information associated with the customer and sets of unrelated information associated with the customer (such as shown in, but not limited to, FIG. 6, or the like). In some embodiments, the microservice system 265d (as controlled by computing system 275) might communicate with the source systems 270 to retrieve data accumulated by the source systems 270. In some cases, the Odata service 265b might include, but is not limited to, an open protocol system that allows the creation and consumption of queryable and interoperable APIs. According to some embodiments, the framework including, without limitation, at least one of the 360° views system 255, the search engine 260, the GraphQL service system 265a, the Odata service system 265b, and the microservice systems 265c and 265d, the source systems 270, and/or the like might serve as data as a service (“DaaS”) API framework for natural integration support with sales, care, and/or repair user experiences for the customer.

According to some embodiments, machine learning or artificial intelligence (“AI”) systems may be used to sort through data that has been accumulated by the source systems 215 and/or the big data systems 225 (or the like) to determine whether each set of data is useful or not useful in terms of providing the robust and holistic view of the customer and the customer's service requirements. In some cases, such machine learning or AI systems may also be used to determine whether each set of data accumulated by the source systems 215 and/or the big data systems 225 (or the like) accurately reflects data associated with the customer or whether there are errors, inaccuracies, and/or intentional (i.e., nefarious) falsehoods in such data (in some cases, based on behavioral analysis of the activities and decisions made by the customer, or the like).

In some embodiments, the task (batch) microservices spring cloud data flow system 205, the data processor 220, and/or the stream microservices spring cloud data flow system 240 might be implemented using one or more scripts or programs written in any suitable programming language, such as Java™, C, C # TM or C++, and/or any scripting language, such as Perl, Python, or TCL, as well as combinations of any programming and/or scripting languages. In some instances, the use of particular programming or scripting language over other programming or scripting languages (among the above-mentioned list of languages, or the like) might result in greater efficiencies and/or speed in implementation.

According to some embodiments, a security or privacy framework (not specifically shown in FIG. 2) might be used as a gateway to provide particular parties or individuals with access to the data associated with the customer, as well as to set the granularity of access to such data (e.g., full access, partial access, very limited access, no access, etc.) (i.e., to establish how much of such data may be accessed by each party or individual). In some instances, attribute-based access control may be implemented to control who (i.e., which parties or individuals) may access which data associated with the customer and how much access (e.g., full access, partial access, very limited access, no access, etc.) to such data may be provided to which parties or individuals.

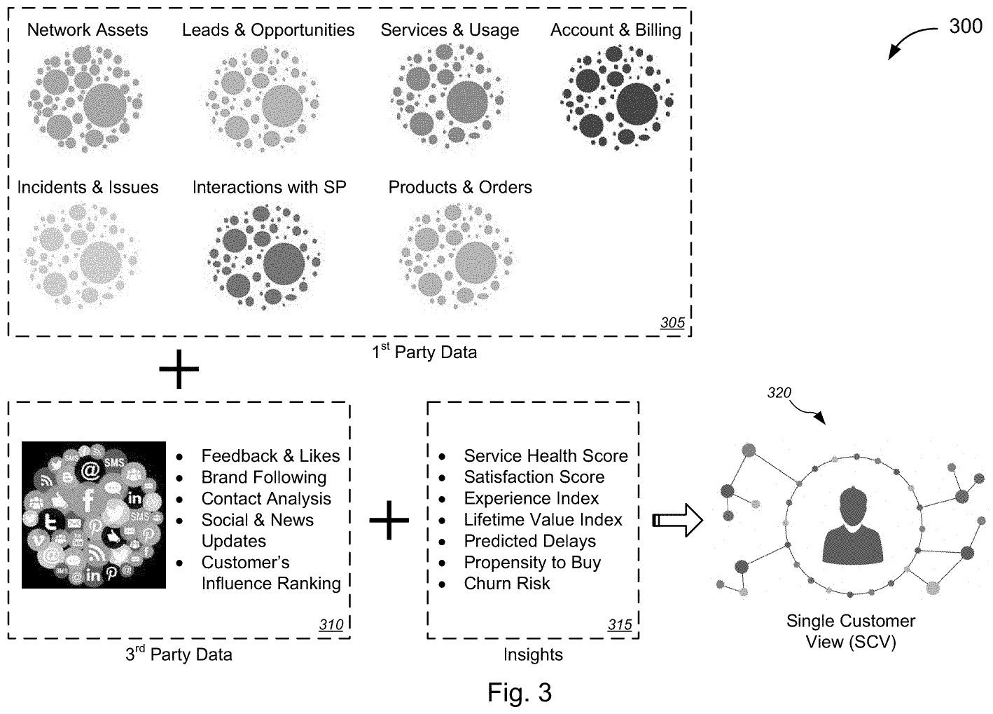

These and other functions of the system 100 (and its components) are described in greater detail above with respect to FIGS. 3-7.

FIG. 3 is a schematic diagram illustrating an example 300 of the generation of a single customer view (“SCV”) that is generated by customer 360° user interface platform and that displays aggregated information associated with a customer, in accordance with various embodiments.

In the non-limiting example 300 of FIG. 3, first party data 305, third party data 310, and insights 315 might be added or aggregated to generate a SCV 320.

In some embodiments, the first party data 305 might include, without limitation, at least one of account information for the customer that is associated with the service provided by the service provider, billing information for the customer that is associated with the service provided by the service provider, product information for each product that is used by the customer and that is associated with the service provided by the service provider, order information for the customer that is associated with products and services ordered by the customer for the service provided by the service provider, communications information for any interactions between the customer and representatives of the service provider, service information for services provided by the service provider that are used by the customer, usage information for usage of products and services provided by the service provider that are used by the customer, information regarding any incidents encountered by the customer when using the products and services provided by the service provider, information regarding any issues encountered by the customer when using the products and services provided by the service provider, information regarding network assets that are utilized to enable the customer to use the products and services provided by the service provider, information regarding leads that the service provider can utilize to initiate communications with the customer to encourage the customer to order new products or services, information regarding leads that the service provider can utilize to initiate communications with one or more potential new customers who are known by the customer to encourage the one or more potential customers to order new products or services, information regarding opportunities that the service provider can take advantage of to encourage the customer to order new products or services, or information regarding opportunities that the service provider can take advantage of to encourage the one or more potential new customers to order new products or services, and/or the like.

According to some embodiments, the third party data 310 might include, but are not limited to, at least one of information regarding feedback or likes posted online by the customer associated with products and services used by the customer that are not associated with the service provider, information regarding brands of products and services that are used by the customer and that are not associated with the service provider, information regarding analytics of online and offline interactions of the customer with service providers and retailers that are performed by third party analysis systems, information regarding social media presence or postings of the customer, or information regarding news articles read by the customer, and/or the like.

In some instances, the insights data 315 associated with the customer might include, without limitation, at least one of a service health score indicative of health of the service provided to the customer by the service provider, a satisfaction score indicative of the customer's satisfaction with the service provided to the customer by the service provider, an experience index indicative of the customer's known experience with the service provided to the customer by the service provider, a lifetime value index indicative of an estimate of a probability that the customer will continue using or ordering services offered by the service provider over a lifetime of the customer, information regarding predicted delays between issues with the service provided by the service provider and encountered by the customer and resolution of the issues by the service provider, information indicative of a propensity of the customer to order new products or services from the service provider, or information indicative of a probability that the customer will present a churn risk to the service provider, and/or the like.

In some embodiments, the SCV 320 might include a graphical representation of groupings of related information associated with the customer and sets of unrelated information associated with the customer (such as shown in, but not limited to, FIG. 5, or the like). Alternatively, or additionally, the SCV 320 might include a tabular representation of groupings of related information associated with the customer and sets of unrelated information associated with the customer (such as shown in, but not limited to, FIG. 6, or the like).

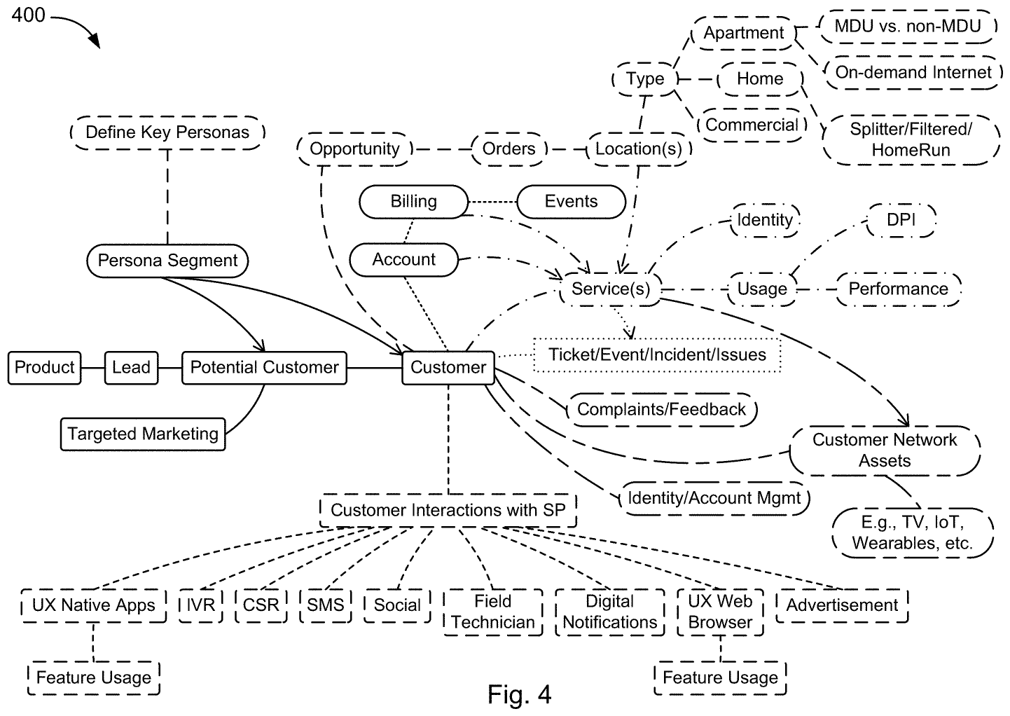

FIG. 4 is a graphical diagram illustrating an example 400 of relationships between a customer icon and icons of each of account information, leads, opportunities, services, issues with services, complaints or feedback, and customer interactions with the service provider, etc., in accordance with various embodiments.

In the non-limiting embodiment 400 of FIG. 4, the customer icon might be linked to a potential customer icon, which might be linked to each of a lead icon and a targeted marketing icon. The lead icon might be linked to a product icon. In some cases, a define key personas icon (which might represent defining key personas for consumers and/or businesses (e.g., small and midsize businesses (“SMBs”), small and midsize enterprises (“SMEs”), large enterprises, nationwide enterprises, international enterprises, government agencies, etc.)) might link with a persona segment icon, which might link to each of the potential customer icon and the customer icon. The customer icon might link to an opportunity icon, which might link to an orders icon, which might link to a location(s) icon, which might link to a type icon, which might link to each of an apartment icon, a home icon, and a commercial icon. The apartment icon might link to a multiple dwelling unit (“MDU”) vs. non-MDU icon and to an on-demand Internet icon. The home icon might link to a splitter/filtered/home run icon (herein, home run might refer to a dedicated connection to digital subscriber line (“DSL”) or the like).

In some cases, the customer icon might link to an account icon, which might link to a billing icon, which might link to an events icon. In some instances, the customer icon might link to a service(s) icon, which might link to an identity icon and a usage icon, which might be linked to a deep packet inspection (“DPI”) icon and a performance icon. In some embodiments, each of the account icon, the billing icon, and the location(s) icon might further link to the service(s) icon.

According to some embodiments, the customer icon might link to each of a ticket/event/incident/issues icon, a complaints/feedback icon, a customer network assets icon (which might link to a TV, Internet of Things (“IoT”), wearables, etc. icon), and an identity/account management icon, etc. In some cases, the service(s) icon might further link to each of the ticket/event/incident/issues icon and the customer network assets icon.

In some embodiments, the customer icon might further link to a customer interactions with service provider icon, which might link to each of at least one of a user experience (“UX”) native apps icon (which might link to a feature usage icon), interactive voice response (“IVR”) icon, a corporate social responsibility (“CSR”) icon, a short message service (“SMS”) icon, a social icon, a field technician icon, a digital notifications icon, a UX web browser icon (which might link to a feature usage icon), and/or an advertisement icon, and/or the like.

Although FIG. 4 illustrates particular relationships amongst the various icons, the various embodiments are not so limited, and the various icons described above may be linked with each other in other relationships.

FIG. 5 is a schematic diagram illustrating a user device 500 used by users that present graphical user interfaces configured for displaying an example of a graphical version of a SCV, in accordance with the various embodiments.

The embodiment as represented in FIG. 5 is merely illustrative and is not intended to limit the scope of the various embodiments. For example, although the graphical user interface of FIG. 5 depicts a line-by-line or line-to-line type GUI, various embodiments may employ a drag-and-drop type GUI (not shown) that allows for more intuitive graphical interaction between a customer and the icons representing the customer, account information, billing information, services information, issues/problems information, communications information, detailed information, and/or the like.

In FIG. 5, although a tablet computer is shown as the user device 500, any suitable user device—including, but not limited to, display device(s) 180 of FIG. 1, which might include, without limitation, at least one of a tablet computer, a smart phone, a mobile phone, a laptop computer, a desktop computer, a television, a monitor, and/or the like.

As shown in the embodiment of FIG. 5, user device 500 might comprise a device housing 505 and a display 505a (which may be a touchscreen display or a non-touchscreen display). An app, an application window, program window or portal (e.g., web portal or the like) may be displayed on the display 505a. In the non-limiting example of FIG. 5, the app or portal 510 running on the user device 500 is a user interface illustrating a single customer view (“SCV”), although the various embodiments are not limited to such an app or portal, as described herein, and can be any suitable app or portal. The app or portal 510 displayed in display 505a might provide a user (e.g., a technician, a telephone agent, a web-based agent, a chat agent, or other representative, etc. of the service provider, or the like) with the ability, functionality, or options to display and customize a graphical representation of groupings of related information associated with the customer and sets of unrelated information associated with the customer. The app or portal 510 displayed in display 505a might further provide the user with the ability, functionality, or options to map and modify relationships amongst icons associated with the customer, including, but not limited to, account information icons 515, order icons 520, conversation icons 525, service or product icons 530, issues or problems icons 535, detail information icons 540, billing information icons 545, and an account information display field 550.

In some cases, the app or portal 510 might also display control icons or buttons 555, including buttons (typically, soft buttons or the like) for adding/registering new icons, relationships, new hardware/network resources, etc.; for removing/de-registering icons, relationships, hardware/network resources, etc.; for editing or mapping relationships and/or options for particular or selected icons, relationships, hardware/network resources, and/or the like; for accessing menu options; for undoing changes; for searching for particular icons, relationships, hardware/network resources, etc.; and/or the like.

In the non-limiting embodiment of FIG. 5, selecting or highlighting particular icons might display a pop-up window or panel that provides information regarding the selected or highlighted particular icon, what the particular icon represents, the relationships amongst icons, etc.

Although FIG. 5 illustrates particular relationships amongst the various icons, the various embodiments are not so limited, and the various icons described above may be linked with each other in other relationships.

FIG. 6 is a schematic diagram illustrating a user device 600 used by users that present graphical user interfaces configured for displaying an example of a tabular version of a SCV, in accordance with the various embodiments.

The embodiment as represented in FIG. 6 is merely illustrative and is not intended to limit the scope of the various embodiments. For example, although the graphical user interface of FIG. 6 depicts a line-by-line or line-to-line type GUI, various embodiments may employ a drag-and-drop type GUI (not shown) that allows for more intuitive graphical interaction between the user and the icons representing a customer, account information, billing information, services information, issues/problems information, communications information, detailed information, and/or the like.

In FIG. 6, although a tablet computer is shown as the user device 600, any suitable user device—including, but not limited to, display device(s) 180 of FIG. 1, which might include, without limitation, at least one of a tablet computer, a smart phone, a mobile phone, a laptop computer, a desktop computer, a television, a monitor, and/or the like.

As shown in the embodiment of FIG. 6, user device 600 might comprise a device housing 605 and a display 605a (which may be a touchscreen display or a non-touchscreen display). An app, an application window, program window or portal (e.g., web portal or the like) may be displayed on the display 605a. In the non-limiting example of FIG. 6, the app or portal 610 running on the user device 600 is a user interface illustrating a single customer view (“SCV”), although the various embodiments are not limited to such an app or portal, as described herein, and can be any suitable app or portal. The app or portal 610 displayed in display 605a might provide a user (e.g., a technician, a telephone agent, a web-based agent, a chat agent, or other representative, etc. of the service provider) with the ability, functionality, or options to display and customize sub-panels or sub-windows representing groupings of related information associated with the customer and sets of unrelated information associated with the customer.

In some cases, the app or portal 610 might also display an icon 615 of the service provided by the service provider, a search field 620, a plurality of sub-panels or sub-windows 625, and/or the like. The plurality of sub-panels or sub-windows 625 might include, without limitation, a customer information sub-panel or sub-window, an account information sub-panel or sub-window, a customer contact information sub-panel or sub-window, an order information sub-panel or sub-window, an insights sub-panel or sub-window, or a product information sub-panel or sub-window, and/or the like.

In the non-limiting embodiment of FIG. 6, selecting or highlighting particular portions of one or more of the plurality of sub-panels or sub-windows might allow the user to cause the SCV to display information regarding the selected or highlighted particular icon, what the particular icon represents, the relationship, etc.

Although FIG. 6 illustrates particular relationships amongst the various aspects and information associated with the customer, the various embodiments are not so limited, and the various sub-panels or sub-windows described above may be may display other relationships amongst the customer and the various aspects of the customer's service as provided by the service provider and/or other information associated with the customer.

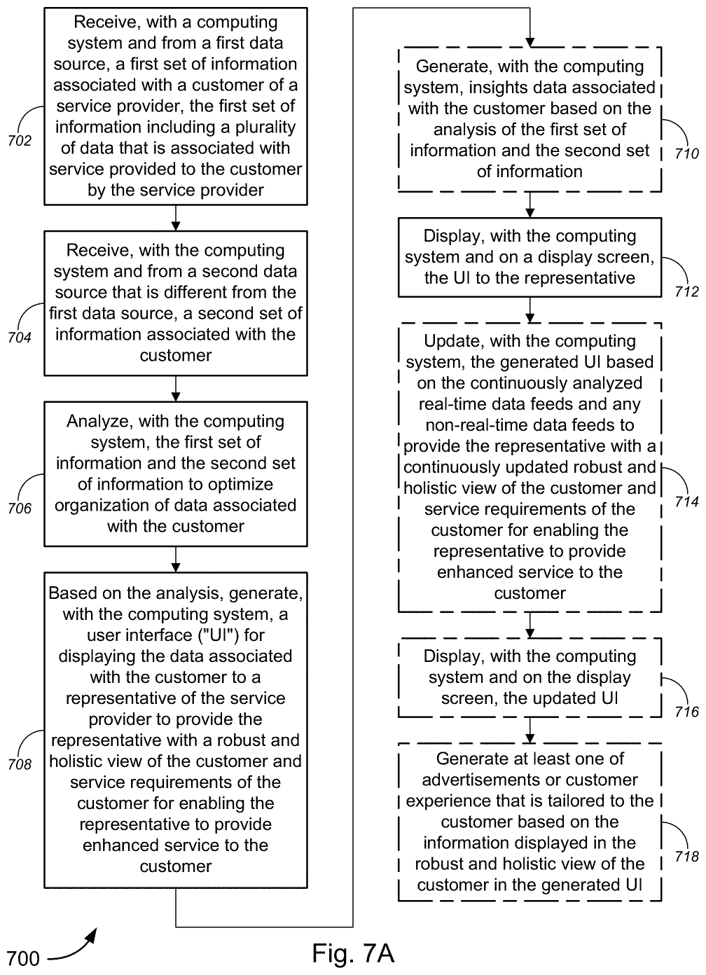

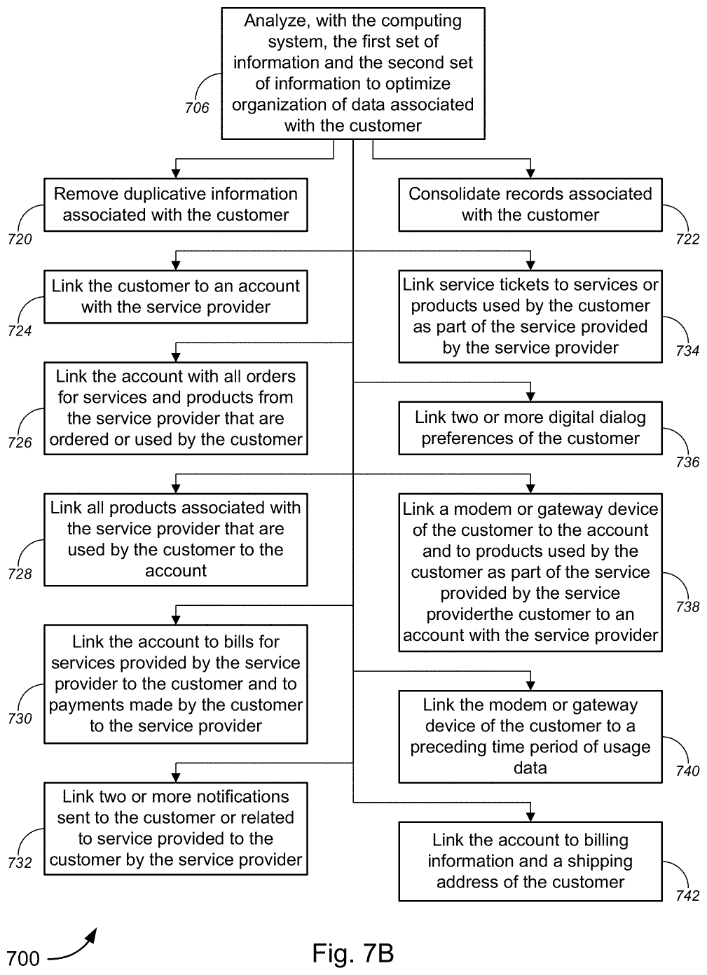

FIGS. 7A and 7B (collectively, “FIG. 7”) are flow diagrams illustrating a method 700 for implementing customer 360° user interface platform for displaying aggregated information associated with each of a plurality of customers, in accordance with various embodiments.

While the techniques and procedures are depicted and/or described in a certain order for purposes of illustration, it should be appreciated that certain procedures may be reordered and/or omitted within the scope of various embodiments. Moreover, while the method 700 illustrated by FIG. 7 can be implemented by or with (and, in some cases, are described below with respect to) the systems, user devices, examples, or embodiments 100, 200, 300, 400, 500, and 600 of FIGS. 1, 2, 3, 4, 5, and 6, respectively (or components thereof), such methods may also be implemented using any suitable hardware (or software) implementation. Similarly, while each of the systems, user devices, examples, or embodiments 100, 200, 300, 400, 500, and 600 of FIGS. 1, 2, 3, 4, 5, and 6, respectively (or components thereof), can operate according to the method 700 illustrated by FIG. 7 (e.g., by executing instructions embodied on a computer readable medium), the systems, user devices, examples, or embodiments 100, 200, 300, 400, 500, and 600 of FIGS. 1, 2, 3, 4, 5, and 6 can each also operate according to other modes of operation and/or perform other suitable procedures.

In the non-limiting embodiment of FIG. 7A, method 700, at block 702, might comprise receiving, with a computing system and from a first data source, a first set of information associated with a customer of a service provider, the first set of information including a plurality of data that is associated with service provided to the customer by the service provider. At block 704, method 700 might comprise receiving, with the computing system and from a second data source that is different from the first data source, a second set of information associated with the customer.

In some embodiments, the first set of information might include, without limitation, at least one of account information for the customer that is associated with the service provided by the service provider, billing information for the customer that is associated with the service provided by the service provider, product information for each product that is used by the customer and that is associated with the service provided by the service provider, order information for the customer that is associated with products and services ordered by the customer for the service provided by the service provider, communications information for any interactions between the customer and representatives of the service provider, service information for services provided by the service provider that are used by the customer, usage information for usage of products and services provided by the service provider that are used by the customer, information regarding any incidents encountered by the customer when using the products and services provided by the service provider, information regarding any issues encountered by the customer when using the products and services provided by the service provider, information regarding network assets that are utilized to enable the customer to use the products and services provided by the service provider, information regarding leads that the service provider can utilize to initiate communications with the customer to encourage the customer to order new products or services, information regarding leads that the service provider can utilize to initiate communications with one or more potential new customers who are known by the customer to encourage the one or more potential customers to order new products or services, information regarding opportunities that the service provider can take advantage of to encourage the customer to order new products or services, or information regarding opportunities that the service provider can take advantage of to encourage the one or more potential new customers to order new products or services, and/or the like. In some cases, the first set of information might include all data that is associated with service provided to the customer by the service provider.

According to some embodiments, the second set of information might include data that is associated with the customer but is not associated with the service provided by the service provider. In some instances, the second set of information might include, but is not limited to, at least one of information regarding feedback or likes posted online by the customer associated with products and services used by the customer that are not associated with the service provider, information regarding brands of products and services that are used by the customer and that are not associated with the service provider, information regarding analytics of online and offline interactions of the customer with service providers and retailers that are performed by third party analysis systems, information regarding social media presence or postings of the customer, or information regarding news articles read by the customer, and/or the like.

Method 700 might further comprise, at block 706, analyzing, with the computing system, the first set of information and the second set of information to optimize organization of data associated with the customer. Method 700 might further comprise, based on the analysis, generating, with the computing system, a user interface (“UI”) for displaying the data associated with the customer to a representative of the service provider to provide the representative with a robust and holistic view of the customer and service requirements of the customer for enabling the representative to provide enhanced service to the customer (block 708).

At optional block 710, method 700 might comprise generating, with the computing system, insights data associated with the customer based on the analysis of the first set of information and the second set of information. In some cases, the generated insights data associated with the customer might include, without limitation, at least one of a service health score indicative of health of the service provided to the customer by the service provider, a satisfaction score indicative of the customer's satisfaction with the service provided to the customer by the service provider, an experience index indicative of the customer's known experience with the service provided to the customer by the service provider, a lifetime value index indicative of an estimate of a probability that the customer will continue using or ordering services offered by the service provider over a lifetime of the customer, information regarding predicted delays between issues with the service provided by the service provider and encountered by the customer and resolution of the issues by the service provider, information indicative of a propensity of the customer to order new products or services from the service provider, or information indicative of a probability that the customer will present a churn risk to the service provider, and/or the like.

Method 700, at block 712, might comprise displaying, with the computing system and on a display screen, the UI to the representative. According to some embodiments, the generated UI might be a graphical representation of groupings of related information associated with the customer and sets of unrelated information associated with the customer. Alternatively, and/or additionally, the generated UI might be a tabular representation of sub-panels or sub-windows representing groupings of related information associated with the customer and sets of unrelated information associated with the customer.

In some embodiments, at least one of receiving the first set of information from the first data source or receiving the second set of information from the second data source might comprise receiving real-time data feeds of information associated with the customer, and analyzing the first set of information and the second set of information might comprise continuously analyzing the received real-time data feeds and any non-real-time data feeds to optimize the organization of data associated with the customer. In such cases, the method might further comprise: updating, with the computing system, the generated UI based on the continuously analyzed real-time data feeds and any non-real-time data feeds to provide the representative with a continuously updated robust and holistic view of the customer and service requirements of the customer for enabling the representative to provide enhanced service to the customer (optional block 714); and displaying, with the computing system and on the display screen, the updated UI (optional block 716).

At optional block 718, method 700 might further comprise generating at least one of advertisements or customer experience that is tailored to the customer based on the information displayed in the robust and holistic view of the customer in the generated UI.

Referring to FIG. 7B, analyzing the first set of information and the second set of information to optimize organization of data associated with the customer (at block 706) might comprise at least one of removing duplicative information associated with the customer (block 720) and/or consolidating records associated with the customer (block 722). In some embodiments, analyzing the first set of information and the second set of information might comprise performing at least one of: linking, with the computing system, the customer to an account with the service provider (block 724); linking, with the computing system, the account with all orders for services and products from the service provider that are ordered or used by the customer (block 726); linking, with the computing system, all products associated with the service provider that are used by the customer to the account (block 728); linking, with the computing system, the account to bills for services provided by the service provider to the customer and to payments made by the customer to the service provider (block 730); linking, with the computing system, two or more notifications sent to the customer or related to service provided to the customer by the service provider (block 732); linking, with the computing system, service tickets to services or products used by the customer as part of the service provided by the service provider (block 734); linking, with the computing system, two or more digital dialog preferences of the customer (block 736); linking, with the computing system, a modem or gateway device of the customer to the account and to products used by the customer as part of the service provided by the service provider (block 738); linking, with the computing system, the modem or gateway device of the customer to a preceding time period of usage data (block 740); or linking, with the computing system, the account to billing information and a shipping address of the customer (block 742); and/or the like.

Exemplary System and Hardware Implementation

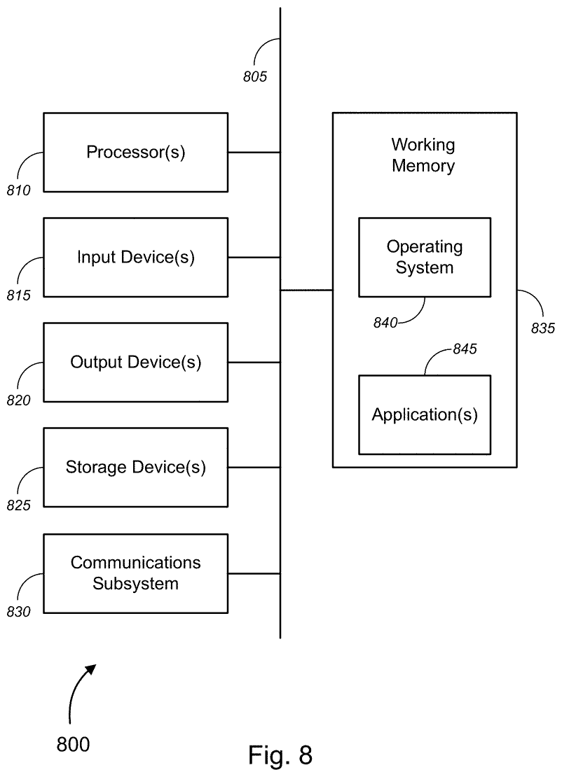

FIG. 8 is a block diagram illustrating an exemplary computer or system hardware architecture, in accordance with various embodiments. FIG. 8 provides a schematic illustration of one embodiment of a computer system 800 of the service provider system hardware that can perform the methods provided by various other embodiments, as described herein, and/or can perform the functions of computer or hardware system (i.e., computing systems 105 and 275, gateway devices 125a-125n, user devices 135a-135n and 140a-140n, third party servers 150a-150n and 230a-230n, data aggregator 160, advertisement and/or experience generator 170, display device(s) 180, task microservice systems 210a-210n, data processor 220, query engine 235a, workflow scheduler 235b, data warehouse 235c, file system 235d, stream microservice systems 245a-245n, data visualization system 250, GraphQL service system 265a, Odata service system 265b, and microservice systems 265c and 265d, etc.), as described above. It should be noted that FIG. 8 is meant only to provide a generalized illustration of various components, of which one or more (or none) of each may be utilized as appropriate. FIG. 8, therefore, broadly illustrates how individual system elements may be implemented in a relatively separated or relatively more integrated manner.

The computer or hardware system 800—which might represent an embodiment of the computer or hardware system (i.e., computing systems 105 and 275, gateway devices 125a-125n, user devices 135a-135n and 140a-140n, third party servers 150a-150n and 230a-230n, data aggregator 160, advertisement and/or experience generator 170, display device(s) 180, task microservice systems 210a-210n, data processor 220, query engine 235a, workflow scheduler 235b, data warehouse 235c, file system 235d, stream microservice systems 245a-245n, data visualization system 250, GraphQL service system 265a, Odata service system 265b, and microservice systems 265c and 265d, etc.), described above with respect to FIGS. 1-7—is shown comprising hardware elements that can be electrically coupled via a bus 805 (or may otherwise be in communication, as appropriate). The hardware elements may include one or more processors 810, including, without limitation, one or more general-purpose processors and/or one or more special-purpose processors (such as microprocessors, digital signal processing chips, graphics acceleration processors, and/or the like); one or more input devices 815, which can include, without limitation, a mouse, a keyboard, and/or the like; and one or more output devices 820, which can include, without limitation, a display device, a printer, and/or the like.

The computer or hardware system 800 may further include (and/or be in communication with) one or more storage devices 825, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 800 might also include a communications subsystem 830, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 830 may permit data to be exchanged with a network (such as the network described below, to name one example), with other computer or hardware systems, and/or with any other devices described herein. In many embodiments, the computer or hardware system 800 will further comprise a working memory 835, which can include a RAM or ROM device, as described above.

The computer or hardware system 800 also may comprise software elements, shown as being currently located within the working memory 835, including an operating system 840, device drivers, executable libraries, and/or other code, such as one or more application programs 845, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 825 described above. In some cases, the storage medium might be incorporated within a computer system, such as the system 800. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 800 and/or might take the form of source and/or installable code, which, upon compilation and/or installation on the computer or hardware system 800 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 800) to perform methods in accordance with various embodiments of the invention. According to a set of embodiments, some or all of the procedures of such methods are performed by the computer or hardware system 800 in response to processor 810 executing one or more sequences of one or more instructions (which might be incorporated into the operating system 840 and/or other code, such as an application program 845) contained in the working memory 835. Such instructions may be read into the working memory 835 from another computer readable medium, such as one or more of the storage device(s) 825. Merely by way of example, execution of the sequences of instructions contained in the working memory 835 might cause the processor(s) 810 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 800, various computer readable media might be involved in providing instructions/code to processor(s) 810 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 825. Volatile media includes, without limitation, dynamic memory, such as the working memory 835. In some alternative embodiments, a computer readable medium may take the form of transmission media, which includes, without limitation, coaxial cables, copper wire, and fiber optics, including the wires that comprise the bus 805, as well as the various components of the communication subsystem 830 (and/or the media by which the communications subsystem 830 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 800. These signals, which might be in the form of electromagnetic signals, acoustic signals, optical signals, and/or the like, are all examples of carrier waves on which instructions can be encoded, in accordance with various embodiments of the invention.

The communications subsystem 830 (and/or components thereof) generally will receive the signals, and the bus 805 then might carry the signals (and/or the data, instructions, etc. carried by the signals) to the working memory 835, from which the processor(s) 805 retrieves and executes the instructions. The instructions received by the working memory 835 may optionally be stored on a storage device 825 either before or after execution by the processor(s) 810.

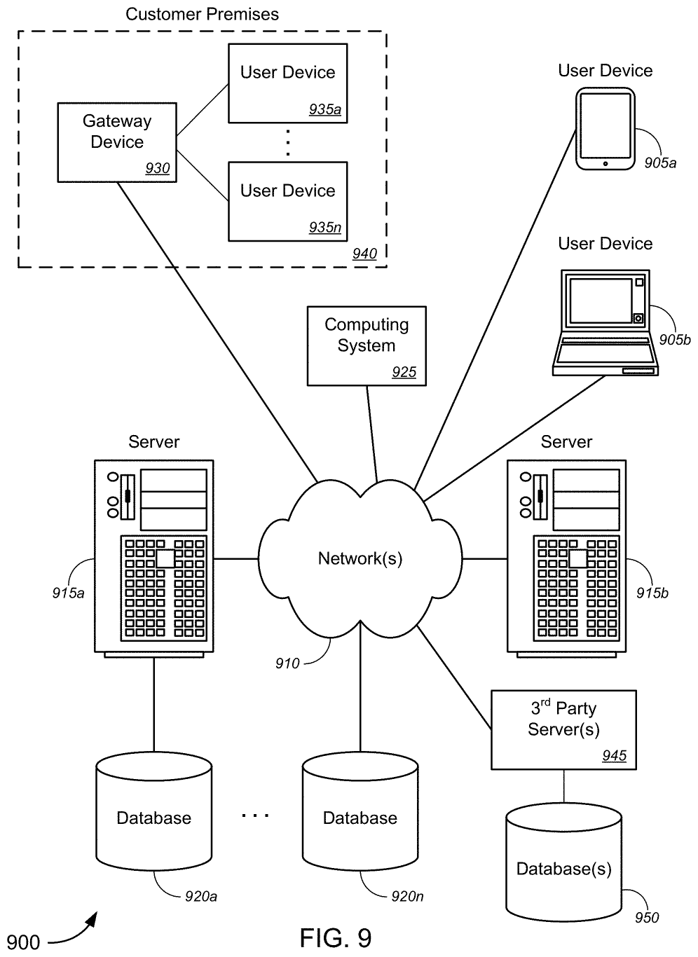

As noted above, a set of embodiments comprises methods and systems for implementing user interface platforms for displaying information, and, more particularly, to methods, systems, and apparatuses for implementing customer 360° user interface platform for displaying aggregated information associated with each of a plurality of customers. FIG. 9 illustrates a schematic diagram of a system 900 that can be used in accordance with one set of embodiments. The system 900 can include one or more user computers, user devices, or customer devices 905. A user computer, user device, or customer device 905 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 905 can also have any of a variety of applications, including one or more applications configured to perform methods provided by various embodiments (as described above, for example), as well as one or more office applications, database client and/or server applications, and/or web browser applications. Alternatively, a user computer, user device, or customer device 905 can be any other electronic device, such as a thin-client computer, Internet-enabled mobile telephone, and/or personal digital assistant, capable of communicating via a network (e.g., the network(s) 910 described below) and/or of displaying and navigating web pages or other types of electronic documents. Although the exemplary system 900 is shown with two user computers, user devices, or customer devices 905, any number of user computers, user devices, or customer devices can be supported.

Certain embodiments operate in a networked environment, which can include a network(s) 910. The network(s) 910 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 910 (similar to network(s) 120 FIG. 1, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 915. Each of the server computers 915 may be configured with an operating system, including, without limitation, any of those discussed above, as well as any commercially (or freely) available server operating systems. Each of the servers 915 may also be running one or more applications, which can be configured to provide services to one or more clients 905 and/or other servers 915.

Merely by way of example, one of the servers 915 might be a data server, a web server, a cloud computing device(s), or the like, as described above. The data server might include (or be in communication with) a web server, which can be used, merely by way of example, to process requests for web pages or other electronic documents from user computers 905. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 905 to perform methods of the invention.

The server computers 915, in some embodiments, might include one or more application servers, which can be configured with one or more applications accessible by a client running on one or more of the client computers 905 and/or other servers 915. Merely by way of example, the server(s) 915 can be one or more general purpose computers capable of executing programs or scripts in response to the user computers 905 and/or other servers 915, including, without limitation, web applications (which might, in some cases, be configured to perform methods provided by various embodiments). Merely by way of example, a web application can be implemented as one or more scripts or programs written in any suitable programming language, such as Java™, C, C # TM or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 905 and/or another server 915. In some embodiments, an application server can perform one or more of the processes for implementing user interface platforms for displaying information, and, more particularly, to methods, systems, and apparatuses for implementing customer 360° user interface platform for displaying aggregated information associated with each of a plurality of customers, as described in detail above. Data provided by an application server may be formatted as one or more web pages (comprising HTML, JavaScript, etc., for example) and/or may be forwarded to a user computer 905 via a web server (as described above, for example). Similarly, a web server might receive web page requests and/or input data from a user computer 905 and/or forward the web page requests and/or input data to an application server. In some cases, a web server may be integrated with an application server.

In accordance with further embodiments, one or more servers 915 can function as a file server and/or can include one or more of the files (e.g., application code, data files, etc.) necessary to implement various disclosed methods, incorporated by an application running on a user computer 905 and/or another server 915. Alternatively, as those skilled in the art will appreciate, a file server can include all necessary files, allowing such an application to be invoked remotely by a user computer, user device, or customer device 905 and/or server 915.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 920a-920n (collectively, “databases 920”). The location of each of the databases 920 is discretionary: merely by way of example, a database 920a might reside on a storage medium local to (and/or resident in) a server 915a (and/or a user computer, user device, or customer device 905). Alternatively, a database 920n can be remote from any or all of the computers 905, 915, so long as it can be in communication (e.g., via the network 910) with one or more of these. In a particular set of embodiments, a database 920 can reside in a storage-area network (“SAN”) familiar to those skilled in the art. (Likewise, any necessary files for performing the functions attributed to the computers 905, 915 can be stored locally on the respective computer and/or remotely, as appropriate.) In one set of embodiments, the database 920 can be a relational database, such as an Oracle database, that is adapted to store, update, and retrieve data in response to SQL-formatted commands. The database might be controlled and/or maintained by a database server, as described above, for example.

According to some embodiments, system 900 might further comprise a computing system 925 (similar to computing systems 105 and 275 of FIGS. 1 and 2, or the like), a gateway device 930 (similar to gateway devices 125a-125n of FIG. 1, or the like), user devices 935a-935n (similar to user devices 135a-135n and 140a-140n of FIG. 1, or the like), the gateway device 930 and the user devices 935a-935n being disposed within customer premises 940. System 900 might further comprise third party server(s) 945 (similar to third party servers 150a-150n and 230a-230n of FIGS. 1 and 2, or the like), and database(s) 950.

In operation, the computing system 925 might receive, from a first data source, a first set of information associated with a customer of a service provider, the first set of information including a plurality of data that is associated with service provided to the customer by the service provider. The computing system 925 might also receive, from a second data source that is different from the first data source, a second set of information associated with the customer. The computing system 925 might analyze the first set of information and the second set of information to optimize organization of data associated with the customer. Based on the analysis, the computing system 925 might generate a user interface (“UI”) for displaying the data associated with the customer to a representative of the service provider to provide the representative with a robust and holistic view of the customer and service requirements of the customer for enabling the representative to provide enhanced service to the customer. The computing system 925 might display, on a display screen, the UI to the representative.

In some embodiments, the generated UI might be a graphical representation of groupings of related information associated with the customer and sets of unrelated information associated with the customer. Alternatively, the generated UI might be a tabular representation of sub-panels or sub-windows representing groupings of related information associated with the customer and sets of unrelated information associated with the customer.

These and other functions of the system 900 (and its components) are described in greater detail above with respect to FIGS. 1-7.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a computing system and from a first data source, a first set of information associated with a customer of a service provider, the first set of information including a plurality of data that is associated with service provided to the customer by the service provider;
receiving, with the computing system and from a second data source that is different from the first data source, a second set of information associated with the customer;
analyzing, with the computing system, the first set of information and the second set of information to optimize organization of data associated with the customer;
based on the analysis, generating, with the computing system, a user interface (“UI”) for displaying the data associated with the customer to a representative of the service provider to provide the representative with a robust and holistic view of the customer and service requirements of the customer for enabling the representative to provide enhanced service to the customer; and
displaying, with the computing system and on a display screen, the UI to the representative.

2. The method of claim 1, wherein the first set of information comprises at least one of account information for the customer that is associated with the service provided by the service provider, billing information for the customer that is associated with the service provided by the service provider, product information for each product that is used by the customer and that is associated with the service provided by the service provider, order information for the customer that is associated with products and services ordered by the customer for the service provided by the service provider, communications information for any interactions between the customer and representatives of the service provider, service information for services provided by the service provider that are used by the customer, usage information for usage of products and services provided by the service provider that are used by the customer, information regarding any incidents encountered by the customer when using the products and services provided by the service provider, information regarding any issues encountered by the customer when using the products and services provided by the service provider, information regarding network assets that are utilized to enable the customer to use the products and services provided by the service provider, information regarding leads that the service provider can utilize to initiate communications with the customer to encourage the customer to order new products or services, information regarding leads that the service provider can utilize to initiate communications with one or more potential new customers who are known by the customer to encourage the one or more potential customers to order new products or services, information regarding opportunities that the service provider can take advantage of to encourage the customer to order new products or services, or information regarding opportunities that the service provider can take advantage of to encourage the one or more potential new customers to order new products or services.

3. The method of claim 1, wherein the first set of information includes all data that is associated with service provided to the customer by the service provider.

4. The method of claim 1, wherein the second set of information includes data that is associated with the customer but is not associated with the service provided by the service provider.

5. The method of claim 4, wherein the second set of information comprises at least one of information regarding feedback or likes posted online by the customer associated with products and services used by the customer that are not associated with the service provider, information regarding brands of products and services that are used by the customer and that are not associated with the service provider, information regarding analytics of online and offline interactions of the customer with service providers and retailers that are performed by third party analysis systems, information regarding social media presence or postings of the customer, or information regarding news articles read by the customer.

6. The method of claim 1, further comprising:
generating, with the computing system, insights data associated with the customer based on the analysis of the first set of information and the second set of information;
wherein the generated insights data associated with the customer comprises at least one of a service health score indicative of health of the service provided to the customer by the service provider, a satisfaction score indicative of the customer's satisfaction with the service provided to the customer by the service provider, an experience index indicative of the customer's known experience with the service provided to the customer by the service provider, a lifetime value index indicative of an estimate of a probability that the customer will continue using or ordering services offered by the service provider over a lifetime of the customer, information regarding predicted delays between issues with the service provided by the service provider and encountered by the customer and resolution of the issues by the service provider, information indicative of a propensity of the customer to order new products or services from the service provider, or information indicative of a probability that the customer will present a churn risk to the service provider.

7. The method of claim 1, wherein at least one of receiving the first set of information from the first data source or receiving the second set of information from the second data source comprises receiving real-time data feeds of information associated with the customer, wherein analyzing the first set of information and the second set of information comprises continuously analyzing the received real-time data feeds and any non-real-time data feeds to optimize the organization of data associated with the customer, wherein the method further comprises:
updating, with the computing system, the generated UI based on the continuously analyzed real-time data feeds and any non-real-time data feeds to provide the representative with a continuously updated robust and holistic view of the customer and service requirements of the customer for enabling the representative to provide enhanced service to the customer.

8. The method of claim 1, wherein analyzing the first set of information and the second set of information to optimize organization of data associated with the customer comprises removing duplicative information associated with the customer and consolidating records associated with the customer.

9. The method of claim 1, wherein analyzing the first set of information and the second set of information comprises performing at least one of:
linking, with the computing system, the customer to an account with the service provider;
linking, with the computing system, the account with all orders for services and products from the service provider that are ordered or used by the customer;
linking, with the computing system, all products associated with the service provider that are used by the customer to the account;
linking, with the computing system, the account to bills for services provided by the service provider to the customer and to payments made by the customer to the service provider;
linking, with the computing system, two or more notifications sent to the customer or related to service provided to the customer by the service provider;
linking, with the computing system, service tickets to services or products used by the customer as part of the service provided by the service provider;
linking, with the computing system, two or more digital dialog preferences of the customer;
linking, with the computing system, a modem or gateway device of the customer to the account and to products used by the customer as part of the service provided by the service provider;
linking, with the computing system, the modem or gateway device of the customer to a preceding time period of usage data; or
linking, with the computing system, the account to billing information and a shipping address of the customer.

10. The method of claim 1, further comprising:
generating at least one of advertisements or customer experience that is tailored to the customer based on the information displayed in the robust and holistic view of the customer in the generated UI.

11. The method of claim 1, wherein the generated UI is a graphical representation of groupings of related information associated with the customer and sets of unrelated information associated with the customer.

12. The method of claim 1, wherein the generated UI is a tabular representation of sub-panels or sub-windows representing groupings of related information associated with the customer and sets of unrelated information associated with the customer.

13. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
receive, from a first data source, a first set of information associated with a customer of a service provider, the first set of information including a plurality of data that is associated with service provided to the customer by the service provider;
receive, from a second data source that is different from the first data source, a second set of information associated with the customer;
analyze the first set of information and the second set of information to optimize organization of data associated with the customer;
based on the analysis, generate a user interface (“UI”) for displaying the data associated with the customer to a representative of the service provider to provide the representative with a robust and holistic view of the customer and service requirements of the customer for enabling the representative to provide enhanced service to the customer; and
display, on a display screen, the UI to the representative.

14. The apparatus of claim 13, wherein the apparatus comprises one of a server computer over a network, a cloud-based computing system over a network, or a distributed computing system.

15. The apparatus of claim 13, wherein the set of instructions, when executed by the at least one processor, further causes the apparatus to:
generate insights data associated with the customer based on the analysis of the first set of information and the second set of information;
wherein the generated insights data associated with the customer comprises at least one of a service health score indicative of health of the service provided to the customer by the service provider, a satisfaction score indicative of the customer's satisfaction with the service provided to the customer by the service provider, an experience index indicative of the customer's known experience with the service provided to the customer by the service provider, a lifetime value index indicative of an estimate of a probability that the customer will continue using or ordering services offered by the service provider over a lifetime of the customer, information regarding predicted delays between issues with the service provided by the service provider and encountered by the customer and resolution of the issues by the service provider, information indicative of a propensity of the customer to order new products or services from the service provider, or information indicative of a probability that the customer will present a churn risk to the service provider.

16. The apparatus of claim 13, wherein analyzing the first set of information and the second set of information to optimize organization of data associated with the customer comprises removing duplicative information associated with the customer and consolidating records associated with the customer.

17. The apparatus of claim 13, wherein analyzing the first set of information and the second set of information comprises performing at least one of:
linking the customer to an account with the service provider;
linking the account with all orders for services and products from the service provider that are ordered or used by the customer;
linking all products associated with the service provider that are used by the customer to the account;
linking the account to bills for services provided by the service provider to the customer and to payments made by the customer to the service provider;
linking two or more notifications sent to the customer or related to service provided to the customer by the service provider;
linking service tickets to services or products used by the customer as part of the service provided by the service provider;
linking two or more digital dialog preferences of the customer;
linking a modem or gateway device of the customer to the account and to products used by the customer as part of the service provided by the service provider;
linking the modem or gateway device of the customer to a preceding time period of usage data; or
linking the account to billing information and a shipping address of the customer.

18. The apparatus of claim 13, wherein the set of instructions, when executed by the at least one processor, further causes the apparatus to:
generate at least one of advertisements or customer experience that is tailored to the customer based on the information displayed in the robust and holistic view of the customer in the generated UI.

19. A system, comprising:
a computing system, comprising:
at least one processor; and
a non-transitory computer readable medium communicatively coupled to the at least one processor, the non-transitory computer readable medium having stored thereon computer software comprising a set of instructions that, when executed by the at least one processor, causes the computing system to:
receive, from a first data source, a first set of information associated with a customer of a service provider, the first set of information including a plurality of data that is associated with service provided to the customer by the service provider;
receive, from a second data source that is different from the first data source, a second set of information associated with the customer;
analyze the first set of information and the second set of information to optimize organization of data associated with the customer;
based on the analysis, generate a user interface (“UI”) for displaying the data associated with the customer to a representative of the service provider to provide the representative with a robust and holistic view of the customer and service requirements of the customer for enabling the representative to provide enhanced service to the customer; and
display, on a display screen, the UI to the representative.

20. The system of claim 19, wherein the computing system comprises one of a server computer over a network, a cloud-based computing system over a network, or a distributed computing system.
